(19) United States
(12) Patent Application Publication
(10) Pub. No.: US 2016/0156690 A1
(43) Pub. Date: Jun. 2, 2016

(54) AUGMENTATION OF STREAMING MEDIA

(71) Applicant: CXENSE ASA, Oslo (NO)

(72) Inventors: Yuliya Lobacheva, Cambridge, MA (US); Nina Zinovieva, Lowell, MA (US); Marie Meteer, Arlington, MA (US)

(21) Appl. No.: 15/018,816

(22) Filed: Feb. 8, 2016

Related U.S. Application Data
(63) Continuation of application No. 12/590,533, filed on Nov. 10, 2009, now abandoned.

(51) Int. Cl. H04L 29/06; G06F 17/28; G10L 15/183; G06Q 30/02; G10L 15/26

(52) U.S. Cl. CPC H04L 65/607; G06Q 30/0251; G06Q 30/0277; G10L 15/265; G10L 15/183; G06F 17/28

(57) ABSTRACT

Methods and apparatus, including computer program products, for augmentation of streaming media. A method includes receiving streaming media, applying a speech-to-text recognizer to the received streaming media, identifying keywords, determining topics, and augmenting speech elements with one or more content items. The one or more content items cab be placed temporally to coincide with speech elements. The method can also include converting the speech elements into text and generating a text-searchable representation of the streaming media.

### CROSS-REFERENCE TO RELATED APPLICATIONS

This application claims the benefit of U.S. Provisional Application No. 61/113,709, filed Nov. 12, 2008, and titled AUGMENTATION OF STREAMING MEDIA, which is incorporated by reference in its entirety.

### BACKGROUND OF THE INVENTION

The invention generally relates to annotating streaming media, and more specifically to augmentation of streaming media.

Streaming media content, such as webcasts, television and radio, typically have static metadata associated with each that is determined well in advance of broadcast. As such, it is very difficult to annotate live content or content that cannot be fully reviewed prior to broadcast.

### SUMMARY OF THE INVENTION

The present invention provides methods and apparatus, including computer program products, for augmentation of streaming media.

In general, in one aspect, the invention features a method including receiving streaming media, applying a speech-to-text recognizer to the received streaming media, identifying keywords, determining topics, and augmenting speech elements with one or more content items.

In another aspect, the invention features a system including a media server configured to receive streaming media, a speech processor for segmenting the streaming media into speech elements and non-speech audio elements, identifying keywords within the speech audio elements, and determining a topic based on one or more of the identified keywords, and an augmentation server for augmenting the streaming media with one or more content items based on the topic.

In still another aspect, the invention features a method including receiving streaming media, selecting a segment of the streaming media, separating the selected segment into speech elements and non-speech audio elements, identifying keywords within each of the speech elements, determining a topic based on one or more of the identified keywords, and augmenting the selected segment with one or more content items selected based on the topic.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

FIG. 3 is a flow diagram.

FIG. 4 is a screen capture.

FIG. 5 is a screen capture.

Like reference numbers and designations in the various drawings indicate like elements.

### DETAILED DESCRIPTION

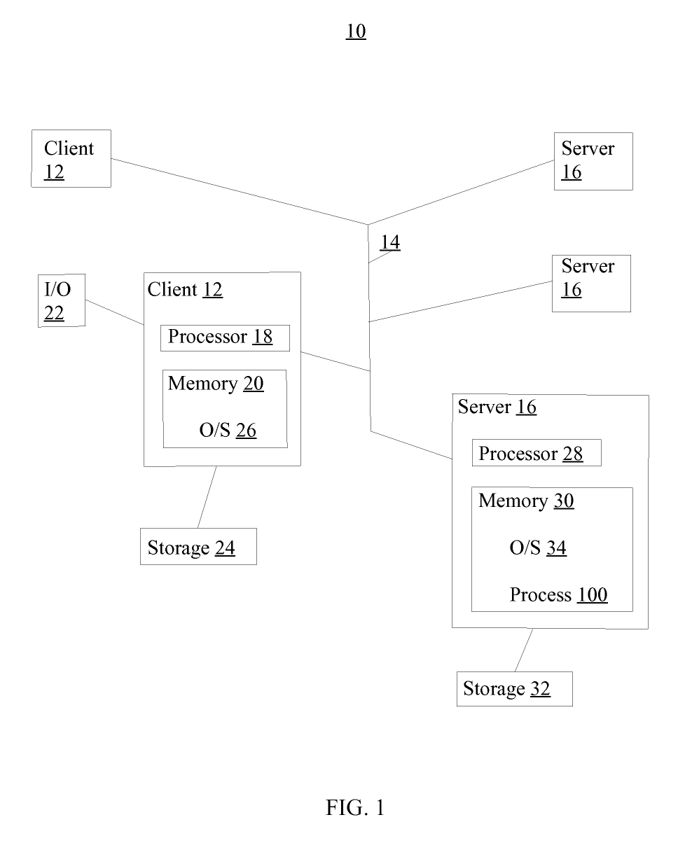

As shown in FIG. 1, a system 10 for implementing augmentation of streaming media can include one or more clients 12 linked via a communications network 14 to one or more servers 16. Each of the clients 12 typically includes a processor 18, memory 20, input/output (I/O) device 22 and a storage device 24. Memory 20 can include an operating system 26.

Each of the clients 12 can be implemented on such hardware as a smart or dumb terminal, network computer, wireless device, personal data assistant (PDA), information appliance, workstation, minicomputer, mainframe computer, or other computing device, that is operated as a general purpose computer or a special purpose hardware device solely used for serving as a client 12 in the system 10.

Each of the clients 12 include client interface software for receiving streaming media and may be implemented in various forms, for example, in the form of a Java® applet that is downloaded to the client 12 and runs in conjunction with a web browser application, such as Firefox®, Opera® or Internet Explorer®. Alternatively, the client software may be in the form of a standalone application, implemented in a language such as Java, C++, C#, VisualBasic or in native processor-executable code. In one embodiment, if executing on the client 12, the client software opens a network connection to a server 16 over a communications network 14 and communicates via that connection to the server(s) 16.

The communications network 14 connects the clients 12 with the server(s) 16. A communication may take place via any media such as telephone lines, Local Area Network (LAN) or Wide Area Network (WAN) links (e.g., T1, T3, 56 kb, X.25), broadband connections (e.g., ISDN, Frame Relay, ATM), wireless links, and so forth. Preferably, the communications network 14 can carry Transmission Control Protocol/Internet Protocol (TCP/IP) protocol communications, and Hypertext Transfer Protocol/Hypertext Transfer Protocol Secure (HTTP/HTTPS) requests made by the client software and the connection between the client software and the server can be communicated over such TCP/IP networks. The type of network is not a limitation, however, and any suitable network may be used. Typical examples of networks that can serve as the communications network 14 include a wireless or wired Ethernet-based intranet, a LAN or WAN, and/or the global communications network known as the Internet, which may accommodate many different communications media and protocols.

Each of the servers 16 typically includes a processor 28, memory 30 and a storage device 32. Memory 20 can include an operating system 34 and a process 100 for augmentation of streaming media.

One or more of the servers 16 may implement a media server, a speech recognition processor and an augmentation server. The media server and speech recognition processor provide application processing components. These components are preferably implemented on one or more server class computers that have sufficient memory, data storage, and processing power and that run a server class operating system (e.g. SUN Solaris, GNU/Linux, Microsoft® Windows XP, and later versions, or other such operating system). Other types of system hardware and software can also be used, depending on the capacity of the device, the number of users and the amount of data received. For example, the server may be part of a server farm or server network, which is a logical group of one or more servers. As another example, there may be multiple servers associated with or connected to each other, or multiple servers may operate independently but with shared data. As is typical in large-scale systems, application software can be implemented in components, with different components running on different server computers, on the same server, or some combination.

The media server can be configured to receive streaming media and the speech processor configured for segmenting the streaming media into speech elements and non-speech audio elements, identifying keywords within the speech audio elements, and determining a topic based on one or more of the identified keywords. The augmentation server can be configured for augmenting the streaming media with one or more content items selected based on the topic and placed temporally to coincide with one of the non-speech audio elements, for example in intervening silence, or with the corresponding speech audio elements.

A data repository server may also be used to store the content used to augment the streaming media. Examples of databases that may be used to implement this functionality include the MySQL® Database Server by Sun Microsystems, the PostgreSQL® Database Server by the PostgreSQL Global Development Group of Berkeley, Calif., and the ORACLE® Database Server offered by ORACLE Corp. of Redwood Shores, Calif.

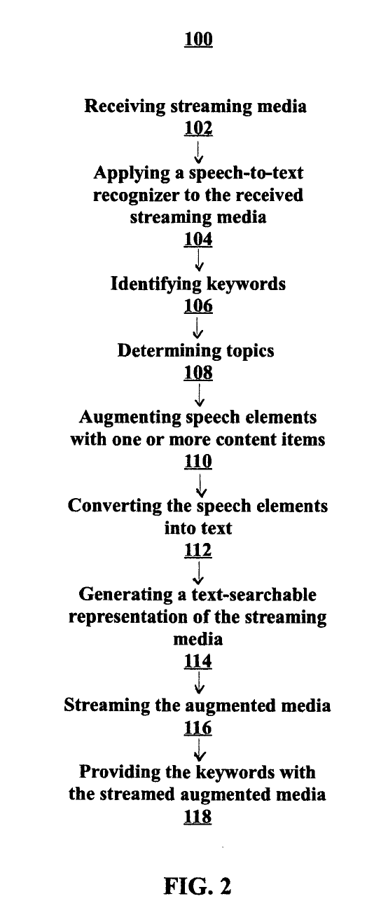

As shown in FIG. 2, process 100 includes receiving (102) streaming media. Streaming media generally refers to video or audio content sent in digital form over the Internet (or other broadcast medium) and played without requiring a user to explicitly save the media file to a hard drive or other physical storage medium first and then initiating a media player. In some implementations, the digital data may be sent in small chunks. In other implementations, larger chunks may be used, sometimes known as a progressive download. In yet other implementations, one large file is sent but playback is enabled to start once the start of the file has been received. The digital data may be sent from one server or from a distributed set of servers. Standard Hypertext Transfer Protocol (HTTP) transport or specialized streaming transports, for example, Real Time Messaging Protocol (RTMP), may be used. In certain implementations, the user may be offered the option to pause, rewind, fast-forward or jump to a different location.

Receiving (102) the streaming media may include preprocessing the received streaming media to segment content. The segmented content can represent speech, silence, applause, laughter, other noise detection, scene change, and/or motion.

Process 100 applies (104) a speech-to-text recognizer to the received streaming media. In general, speech recognition (also known as automatic speech recognition or computer speech recognition) converts spoken words to text. In implementations, the speech-to-text recognizer is a keyword spotter.

Process 100 identifies (106) keywords. In implementations, identified keywords are processed with keywords in editorial metadata associated with the received streaming media. The editorial metadata can include one or more of a title and description.

In implementations, the identified keywords are assigned a confidence score.

In an example, identifying (106) keywords includes applying natural language processing (NLP) to closed captioning/editorial transcripts. In another example, identifying (106) keywords can include applying statistical natural language processing (NLP), a rules-based NLP, a simple editorial keyword list processing, or statistical keyword list processing.

Process 100 determines (108) topics. In implementations, determining (108) topics is based on one or more of the identified keywords, on derivation from a statistical categorization into a known taxonomy of topics, on derivation from a rules-based categorization into a known taxonomy of topics, on filtering from a list of keywords, and/or on composition from a list of keywords.

Process 100 augments (110) speech elements with one or more content items. The content items can be placed temporally to coincide with non-speech elements.

The one or more content items can be selected based on topics or on one or more of the identified keywords. In an example, the content items include advertisements. The advertisements can be inserted within the streaming media itself or shown along side the streaming media on a Web page. The advertisements can reside on an external source or be provided to the topics as metadata to one or more external engines.

Augmenting (110) can be performed while the streaming media is playing or prior to the streaming media playing.

In implementations, augmenting (110) can include an insertion of the one or more content items into the streaming media or spliced into the streaming media by a video/audio player. The streaming media can include a radio broadcast or Internet-streamed audio and/or video.

The one or more content items can be placed within the streaming media at a minimum temporal displacement from the speech elements on which selection of the content items is based.

Process 100 can limit the augmentation to a maximum number of content items. In a specific example, the maximum number of content items is one.

Process 100 can include converting (112) the speech elements into text and generating (114) a text-searchable representation of the streaming media.

Process 100 can include streaming (116) the augmented media. Process 100 can include providing (118) the keywords with the streamed augmented media.

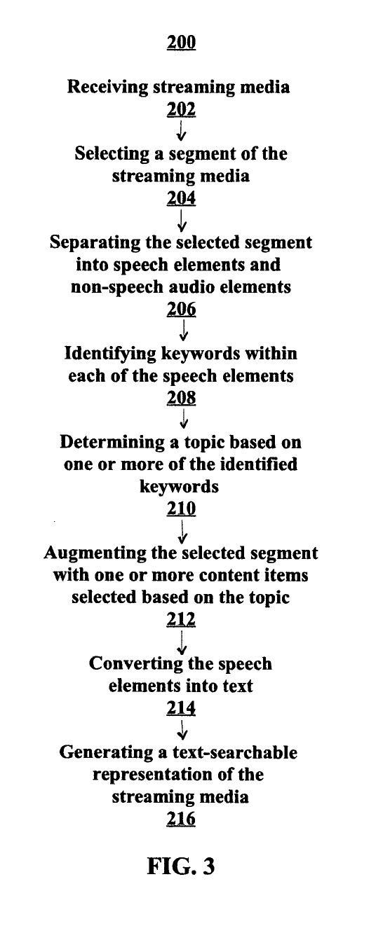

As shown in FIG. 3, a process 200 for augmentation of streaming media includes receiving (202) streaming media. Process 200 selects (204) a segment of the streaming media. Process 200 separates (206) the selected segment into speech elements and non-speech audio elements. The non-speech audio elements may include one or more of silence, applause, music, laughter, and background noise.

Process 200 identifies (208) keywords within each of the speech elements. The identified keywords can be filtered using keywords in editorial metadata associated with the received streaming media. The editorial metadata can include one or more of a title and description.

In one example, identifying (208) keywords includes applying full continuous speech-to-text processing. In another example, identifying (208) keywords includes applying a keyword spotter.

In, still another example, identifying (208) keywords includes applying natural language processing (NLP) to closed captioning/editorial transcripts. In another example, identifying (208) keywords includes applying one of statistical natural language processing (NLP), rules-based NLP, simple editorial keyword list processing, and/or statistical keyword list processing.

Process 200 determines (210) a topic based on one or more of the identified keywords.

Process 200 augments (212) the selected segment with one or more content items. The content items can be selected based on the topic and placed temporally to coincide with one of the non-speech audio elements. In one example, augmenting (212) is performed while the streaming media is playing or prior to the streaming media playing. In another example, augmenting (212) includes an insertion of the one or more content items into the streaming media or spliced into the streaming media by a video/audio player. The content items can be advertisements and the advertisements can be inserted within the streaming media itself or shown along side the streaming media on a Web page.

Process 200 may also include converting (214) the speech elements into text and generating (216) a text-searchable representation of the streaming media.

In one of many implementations, the process for identifying and presenting topic-relevant content within (or in conjunction with) real-time broadcast or streaming media includes four phases. In a first phase, streaming media is received and processed to determine speech and non-speech audio elements.

In a second phase, the speech elements are analyzed using one or more speech recognition processes to identify keywords, which in turn influence the selection of a topic.

In a third phase, the non-speech elements are analyzed to identify sections (e.g., time-slots) during which additional content can be added to the streaming media without (or with a minor) interruption of the primary content.

Fourth, the identified topic influences the selection of content items to be added to the primary content, and placed at the identified time positions. As a result, a user experiences the primary content as intended by the provider, and immediately thereafter (or in some cases during) is presented with a topic-relevant advertisement.

During the first phase, the streaming media is segmented into “chunks.” Chunking the media limits the amount of media analyzed at any one time, and enables selected content to be added shortly after the “chunk” is broadcast. In contrast, automatic labeling of large chunks of media content (e.g., a thirty-minute TV episode) can leave an unacceptable time lag before the labeling information is available to the producer in order to select an advertisement. Furthermore, automatically labeling smaller chunks (e.g., 30 seconds) without regard to natural breaks in the content can create breaks in the middle of words or phrases that may be critical to accurate topic selection. In contrast, the invention determines an optimal “chunk size” based on automatically detected natural boundaries in speech, thereby balancing the need for keywords to determine a topic and the need to place advertisements at acceptable places within the media. Once a chunk is selected, speech elements are separated from non-speech audio elements such as applause, laughter, music or silence.

In some embodiments, chunks can be further divided into utterances (ranging in length from a single phoneme to a few syllables or one or two words) and tagged to identify start and end times for the chunks. For example, if the segmentation process determines that the currently-processed chunk contains ample keywords to determine a topic (or has reached some maximum time limit), the current speech element may be used to identify the start of the next chunk. In this manner, each utterance can be sent to the speech recognition processor to identify keywords and topics.

As an example, the table below shows the distinction between cutting segments every 30 seconds without regard to content as compared to cutting segments based on utterance boundaries. The left hand column of the table includes a transcript from a radio broadcast in which certain words were “cut” at the segmentation boundary. In contrast, the use of natural utterance boundaries to drive segmentation is shown in the right hand column. By segmenting the media at natural breaks in speech, the segments do not contain partial sentences or words, and thus the identification of a topic is more accurate.

TABLE 1
Utterance-based Segmentation

| | |
|---|---|
| Break Every 30 Seconds | Break on Utterance Boundaries |
| Thank you for downloading today's podcasts from | Thank you for downloading today's podcasts from |
| the news group at the Boston Globe. Here's a look at today's | the news group at the Boston Globe. Here's a look at today's |
| top stories. Good morning, I am Hoyt and it is Wednesday | top stories. Good morning, I am Hoyt and it is Wednesday |
| January 16. Presidential hopes on the line as Mitt Romney | January 16. Presidential hopes on the line as Mitt Romney |
| captured his first major victory in the Republican race | captured his first major victory in the Republican race |
| yesterday. Decisively out polling John McCain in Michigan's | yesterday. |
| GOP primary | |
| BREAK AT 0:30 | BREAK AT 0:25.109 |
| The Globe's Hellman and Levenson say the results | Decisively out polling John McCain in Michigan's |
| further scramble the party's nomination contest. With more | GOP primary. The Globe's Hellman and Levenson say the |
| than 515 precincts reporting last night. The former | results further scramble the party's nomination contest. With |
| Massachusetts governor was beating Senator McCain. Mike | more than 515 precincts reporting last night. The former |
| Huckabee, a former Arkansas governor was a distant third. | Massachusetts governor was beating Senator McCain. Mike |
| Romney called his comeback victory a comeback for America | Huckabee, a former Arkansas governor was a distant third. |
| as well. Telling jubilant supporters | |
| BREAK AT 1:00 | BREAK AT 0:54.339 |
| that only a week ago a win looked like it was | Romney called his comeback victory a comeback for |
| impossible. The results infuse energy into his campaign which | America as well. Telling jubilant supporters that only a week |
| had suffered second place finishes in Iowa and New | ago a win looked like it was impossible. The results infuse |
| Hampshire. But it's hard to say what effect the result will have | energy into his campaign which had suffered second place |
| in key votes coming up in South Carolina on Saturday and | finishes in Iowa and New Hampshire. But it's hard to say what |
| Florida at the end of the month, and 25 other states including | effect the result will have in key votes coming up in South |
| Massachusetts that go to the polls February 5. Three different | Carolina on Saturday. |
| Republicans | |
| BREAK AT 1:30 | BREAK AT 1:19.679 |

With chunks identified and parsed, the speech elements may then be processed using various speech-recognition techniques during the second phase to generate metadata describing the streamed media. The metadata may then be used to identify keywords and entities (e.g., proper nouns) that influence the determination of a topic for the streaming media. In some instances, utterances may be grouped into a “window” representing a portion of the streaming media. This window may be fixed (e.g., once the window is processed an entirely new window is generated and analyzed) or moving, such that new utterances are added to the window as others complete processing. The window may be of any length, however a thirty (30) second window provides sufficient content to be analyzed but is short enough that any content added to the streaming media will be presented to the user shortly after the utterances that determined which content to be added.

In the third phase, the non-speech portions of the streaming media are analyzed to determine if they represent a natural break in the audio, thereby enabling the addition of content (e.g., advertisements) in a non-obtrusive manner. For example, long pauses (greater than 5 seconds, for example) of silence or applause following portions of a political speech related to healthcare can be augmented with advertisements for health care providers, requests for contributions to candidates or other topic-relevant ads. The table below includes a segmented transcription of a radio broadcast with the streaming media segmented into chunks with natural breaks and a non-speech segment identified as a possible augmentation point. Each segment includes a start time, a segment type (break, utterance number, or non-speech segment id), the transcript, and an action (no action, send transcript to speech recognition engine, or augment with advertisement). The words identified in bold are recognized by the speech recognition engine influence the selection of metadata and topics for this segment.

| | Segment | | |
|---|---|---|---|
| Time | Type | Transcript | Action |
| 161.4 | Break | Start new chunk at 161.55901 | <none> |
| 161.6 | U26 | Though the coming primaries are wide open | Send to |
| | | and it's already clear that the traditional Republican anti- | SRE |
| | | tax spending message | |
| 170.1 | U27 | Might not satisfy even the GOP's conservative | Send to |
| | | | SRE |
| 173.9 | U28 | Especially in a time of economic unease | Send to |
| | | | SRE |
| 177.2 | SEG4 | Silence for 2.250 seconds | Consider |
| | | | placement of |
| | | | advertisement |
| 179.8 | U29 | Three teenage suicides in eleven months have | Send to |
| | | left Nantucket island shaken and puzzled | SRE |
| 191.6 | Break | Start new chunk at 186.489 | |
| 186.5 | U30 | Globe reporter Andy Kendrick writes that the | Add to |
| | | island residents are trying to figure | next chunk |

By using a moving window of utterances that include the segment being analyzed, “stale” utterances are dropped from the analysis and new utterances are added. In the above example, the selected topic for segments U26-U28 may be identified as “politics” and as utterances U29 and U30 are received, U26 and U27 are dropped out of the moving window and the topic changes to “local news.” Because the data is being delivered with a very low latency from actual broadcast time, users are provided with a quick recap of what is being broadcast.

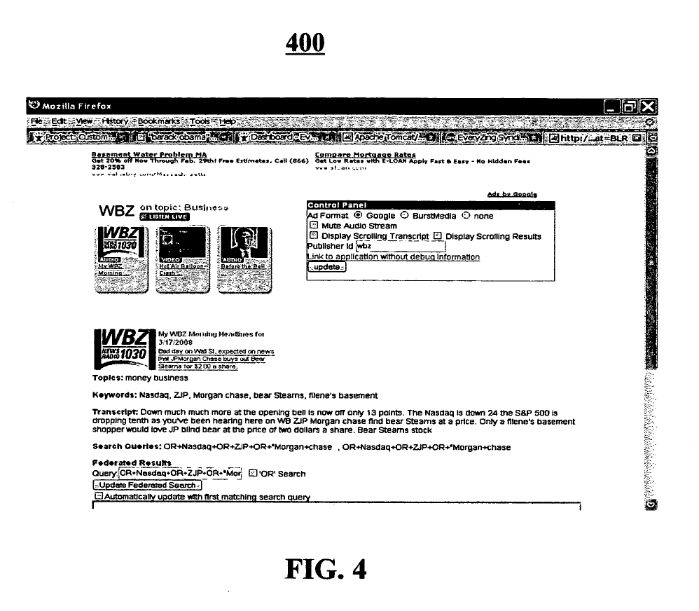

As shown in FIG. 4, a first screen-capture 400 illustrates a web page that includes three podcasts that are available for downloading and/or listening. Because the selected podcast (WBZ Morning Headlines) is loosely related to business and the Boston metro area, the advertisements indicated along the top of the page are tangentially related to these topics. However, the selection of these topics could have been done long before broadcast, and are not particularly relevant.

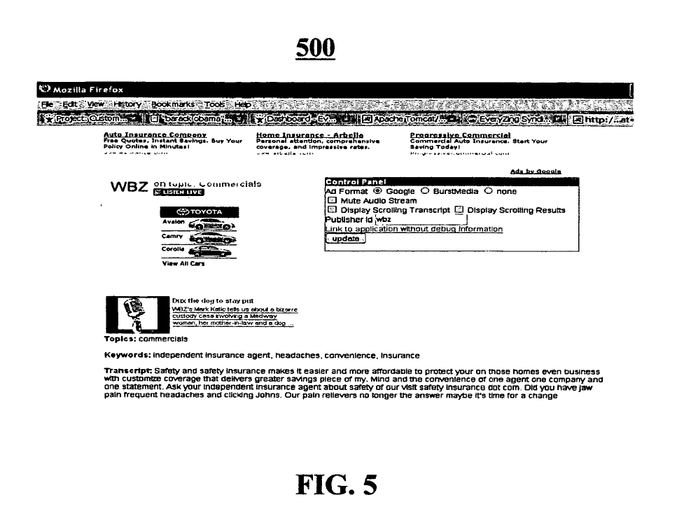

As shown in FIG. 5, a second screen capture 500 illustrates how the techniques described above can identify topics as they occur within streaming media (e.g., a discussion about auto insurance or auto safety) and displays advertisements that are much more relevant.

The techniques described in detail herein enable automatically recognizing keywords and topics as they occur within a broadcast or streamed media. The recognition of key topics occur in a timely manner such that relevant content can be added to, or broadcast with, the media as it is streamed.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method for augmenting streaming media with content items without interrupting primary content of the streaming media, the method comprising:
receiving the streaming media;
segmenting the streaming media into speech elements and non-speech elements;
analyzing the speech elements for at least one keyword;
determining a topic of the steaming media based on the at least one keyword;
selecting at least one content item based on the topic of the streaming media;
analyzing the non-speech elements for identification of at least one time slot in which the at least one content item can be added to the streaming media without interrupting the primary content of the streaming media; and
augmenting the streaming media with the at least one content item, the at least one content item being placed temporally to coincide with the at least one time slot.

2. The computer-implemented method of claim 1 wherein the at least one content item is an advertisement.

3. The computer-implemented method of claim 2 wherein the advertisement is selected by providing the topics as metadata to one or more external engines.

4. The computer-implemented method of claim 2 wherein the advertisement is inserted within the streaming media itself or shown alongside the streaming media on a Web page.

5. The computer-implemented method of claim 2 wherein the advertisement is placed within the streaming media at minimum temporal displacement from the at least one keyword on which selection of the at least one content item is based.

6. The computer-implemented method of claim 1 wherein the advertisement resides on an external source.

7. The computer-implemented method of claim 1 wherein the at least one time slot is greater than five seconds.

8. The computer-implemented method of claim 1 further comprising the step of:
streaming the augmented steaming media to a client device.

9. The computer-implemented method of claim 1 wherein the augmenting step is performed while the streaming media is playing or prior to the streaming media playing.

10. The computer-implemented method of claim 1 wherein the augmenting step further includes an insertion of the at least one content item into the streaming media or spliced into the streaming media by a video/audio player.

11. The computer-implemented method of claim 1 wherein the non-speech elements comprise at least one of silence, applause, music, laughter, and background noise.

12. The computer-implemented method of claim 1 wherein analyzing the speech elements for keywords includes at least one of (a) applying full continuous speech-to-text processing, (b) applying a keyword spotter, (c) applying natural language processing (NLP) to closed captioning/editorial transcripts and (d) applying one of statistical natural language processing (NLP), rules-based NLP, simple editorial keyword list processing, or statistical keyword list processing.

13. A system for augmenting streaming media with content items without interrupting primary content of the streaming media, the system comprising:
(a) a computer server programmed to:
(i) receive the streaming media;
(ii) segment the streaming media into speech elements and non-speech elements;
(iii) analyze the speech elements for keywords;
(iv) determine a topic of the steaming media based on the keywords;
(v) select at least one content item based on the topic of the streaming media;
(vi) analyze the non-speech elements for identification of at least one time slot in which the at least one content item can be added to the streaming media without interrupting the primary content of the streaming media; and
(vii) augment the streaming media with the at least one content item, the at least one content item being placed temporally to coincide with the at least one time slot; and
(b) at least one client device, the at least one client device being coupled to the computer server and capable of receiving the augmented streaming media.

14. The system of claim 13 wherein the at least one content item is an advertisement.

15. The system of claim 14 wherein the advertisement is selected by providing the topics as metadata to one or more external engines.

16. The system of claim 14 wherein the advertisement is inserted within the streaming media itself or shown alongside the streaming media on a Web page.

17. The system of claim 14 wherein the advertisement is placed within the streaming media at minimum temporal displacement from the at least one keyword on which selection of the at least one content item is based.

18. The system of claim 13 wherein the at least one time slot is greater than five seconds.

19. The system of claim 13 wherein the augmenting step is performed while the streaming media is playing or prior to the streaming media playing.

20. The system of claim 13 wherein the augmenting step further includes an insertion of the at least one content item into the streaming media or spliced into the streaming media by a video/audio player.
